(19) United States
(12) Patent Application Publication
(10) Pub. No.: US 2013/0005878 A1
(43) Pub. Date: Jan. 3, 2013

(54) MELT PROCESSABLE COMPOSITION AND METHOD OF MAKING

(75) Inventors: Shaw Ling Hsu, Sunderland, MA (US); Ying Wu, Amherst, MA (US); Christian C. Honeker, Cambridge, MA (US); David J. Bravet, Westborough, MA (US); Darryl William, Groton, MA (US)

(73) Assignees: UNIVERSITY OF MASSACHUSETTS, Boston, MA (US); SAINT-GOBAIN PERFORMANCE PLASTICS CORPORATION, Aurora, OH (US)

(21) Appl. No.: 13/538,618

(22) Filed: Jun. 29, 2012

Related U.S. Application Data
(60) Provisional application No. 61/503,445, filed on Jun. 30, 2011.

(51) Int. Cl. C08L 27/24; C08K 5/3415

(52) U.S. Cl. 524/104

(57) ABSTRACT

A composition includes a) a melt processable polymer including at least one chemical moiety having a partial charge; and b) a nucleating agent having a surface charge that is opposite the partial charge of the chemical moiety of the polymer, wherein the nucleating agent accelerates the rate of crystallization of the melt processable polymer; wherein the nucleating agent has a melting point greater than the melting point of the melt processable polymer. In an embodiment, a method of making the composition is also provided.

### CROSS REFERENCE TO RELATED APPLICATION(S)

The present application claims priority from U.S. Provisional Patent Application No. 61/503,445, filed Jun. 30, 2011, entitled “A MELT PROCESSABLE COMPOSITION AND METHOD OF MAKING,” naming inventors Shaw Ling Hsu, Ying Wu, Christian C. Honeker, David Bravet and Darryl Williams, which application is incorporated by reference herein in its entirety.

### FIELD OF THE DISCLOSURE

This disclosure, in general, relates to a melt processable composition and methods of making the aforementioned melt processable composition.

### BACKGROUND

It is technologically desirable to increase both the rate and extent of crystallization in melt processable polymers. For instance, the control of crystallinity of melt processable polymers is useful to improve properties such as haze as well as mechanical properties. Nucleating agents are widely used to control and enhance the mechanical properties, degree of crystallinity, specific morphological features, dimensional stability, optical transparency (crystallite size) as well as increase the processing speed of the melt processable polymers. Without a nucleating agent, a melt processable polymer may not crystallize at a rate to provide desirable properties for certain applications.

When used, the effectiveness of nucleating agents is dependent upon increasing the surface area and lowering the nucleation barrier to enhance the heterogeneous nucleation process. Unfortunately, the crystallization of melt processable materials, even with the use of a nucleating agent, may produce a material that both forms large crystallites that scatter visible light and forms hazy films, preventing the use of certain melt processable materials for certain applications.

As such, improved compositions including nucleating agents that have improved optical properties as well as mechanical properties are desired.

### SUMMARY

In an embodiment, a composition includes a) a melt processable polymer including at least one chemical moiety having a partial charge; and b) a nucleating agent having a surface charge that is opposite the partial charge of the chemical moiety of the polymer, wherein the nucleating agent accelerates the rate of crystallization of the melt processable polymer; wherein the nucleating agent has a melting point greater than the melting point of the melt processable polymer.

In a particular embodiment, a composition includes a) a melt processable fluoropolymer; and b) a nucleating agent having a positive surface charge, wherein the nucleating agent accelerates the rate of crystallization of the melt processable fluoropolymer; wherein the nucleating agent has a melting point above the melting point of the fluoropolymer, wherein the melting point of the nucleating agent is less than about 20 degrees greater than the melting point of the melt processable polymer.

In another embodiment, a method of making a composition includes providing a melt processable polymer including at least one chemical moiety having a partial charge; and melt blending the melt processable polymer with a nucleating agent at a temperature above the melt temperature of the melt processable polymer, the nucleating agent having a surface charge that is opposite the partial charge of the chemical moiety of the polymer, wherein the nucleating agent has a melting point greater than the melting point of the melt processable polymer.

### BRIEF DESCRIPTION OF THE DRAWINGS

The present disclosure may be better understood, and its numerous features and advantages made apparent to those skilled in the art by referencing the accompanying drawings.

FIG. 1 includes illustrations of chemical structures and melting temperatures of exemplary nucleating agents.

FIG. 2 includes graphical illustrations of differential scanning calorimetry (DSC) of (A) non-isothermal crystallization curves and (B) subsequent melting curves of an exemplary fluoropolymer and an exemplary fluoropolymer with exemplary positive nucleating agents.

FIG. 3 includes graphical illustrations of crystallization rates obtained from differential scanning calorimetric (DSC) data: (A) non-isothermal crystallization curves and (B) subsequent melting curves of an exemplary fluoropolymer and an exemplary fluoropolymer with exemplary negative and neutral nucleating agents.

The use of the same reference symbols in different drawings indicates similar or identical items.

### DETAILED DESCRIPTION

In a particular embodiment, a composition includes a) a melt processable polymer and b) a nucleating agent. In an embodiment, the melt processable polymer includes at least one chemical moiety having a partial charge wherein the nucleating agent has a surface charge that is opposite the partial charge of the chemical moiety of the polymer. The addition of the nucleating agent to the melt processable polymer accelerates the rate of crystallization of the melt processable polymer. In a particular embodiment, the nucleating agent has a melting point greater than the melting point of the melt processable polymer. In a particular embodiment, the resulting composition has desirable optical and mechanical properties.

As used herein, a “melt processable polymer” is a polymer that can melt and flow as well as extrude in any reasonable form such as films, tubes, fibers, molded articles, or sheets. In an embodiment, the melt processable polymer is any reasonable polymer that has a chemical moiety having a partial charge. Notably, the overall charge of the melt processable polymer is neutral. Melt processable polymers have, for example, a carbon backbone with at least one chemical moiety with a partial charge of at least about −0.15 Debye. For instance, the chemical moiety may be a halide, a carbonyl group, an amide group, or the like. In a particular embodiment, the strong partial charge of the chemical moiety of the melt processable polymer and the oppositely charged surface of nucleating agents exhibit a natural affinity through the electrostatic interaction existing between nucleating agents and the melt processable polymer. An exemplary melt processable polymer is a fluoropolymer, a poly(lactic acid), a polyamide, a polyester, and a polycarbonate, and the like. In a particular embodiment, the melt processable polymer is a fluoropolymer or a poly(lactic acid).

In a particular embodiment, the melt processable polymer is a fluoropolymer. Any reasonable fluoropolymer is envisioned. An exemplary fluoropolymer includes a homopolymer, copolymer, terpolymer, or polymer blend formed from a monomer, such as tetrafluoroethylene, hexafluoropropylene, chlorotrifluoroethylene, trifluoroethylene, vinylidene fluoride, vinyl fluoride, perfluoropropyl vinyl ether, perfluoromethyl vinyl ether, or any combination thereof.

The fluoropolymers may include polymers, polymer blends and copolymers including one or more of the above monomers, such as fluorinated ethylene propylene (FEP), ethylene-tretrafluoroethylene (ETFE), poly tetrafluoroethylene-perfluoropropylether (PFA), poly tetrafluoroethylene-perfluoromethylvinylether (MFA), poly tetrafluoroethylene (PTFE), poly vinylidene fluoride (PVDF), ethylene chloro-trifluoroethylene (ECTFE), poly chloro-trifluoroethylene (PCTFE), and tetrafluoroethylene-hexafluoropropylene-vinylidene fluoride (THV). In an embodiment, the fluoropolymer is a poly vinylidene fluoride (PVDF). In further exemplary embodiments, the fluoropolymers may be copolymers of alkene monomers with fluorinated monomers, such as Daikin™ EFEP copolymer by Daikin America, Inc. In an embodiment, the fluoropolymers may include acrylic mixtures, and the like. In a particular embodiment, the fluoropolymer is blended with an acrylic, such as a blend of PVDF with an acrylic, PVDF based copolymers with an acrylic, or combination thereof.

When an acrylic is used, the acrylic polymer may be, for example, an acrylic polymer formed from a monomer having an alkyl group having from 1-4 carbon atoms, a glycidyl group or a hydroxyalkyl group having from 1-4 carbon atoms. A representative acrylic polymer includes poly methacrylate, polymethyl methacrylate, polyethyl methacrylate, polybutyl methacrylate, polyglycidyl methacrylate, polyhydroxyethyl methacrylate, polymethyl acrylate, polyethyl acrylate, polybutyl acrylate, polyglycidyl acrylate, polyhydroxyethyl acrylate or a mixture thereof.

The acrylic polymer may be, for example, an impact grade or impact modified acrylic. Impact-modified acrylic polymers generally include a copolymer of monomers of acrylic monomers with an effective amount of suitable comonomer or graft moiety to produce the desired elastic modulus and impact resistance. An acrylic elastomer, sometimes referred to as acrylate rubber, polyacrylate rubber, polyacrylic elastomer or “ACM” and which is a composition based on a mixture of a polyacrylate and polymethacrylate, a polyacrylate and ethylene methacrylate copolymer (“EMAC”) (such as Chevron Chemicals EMAC 2260), or a polyacrylate and ethylene butylacrylate (“EBAC”), can be used. Alternatively, a thermoplastic impact-modified acrylic polymer can be a blend of a clear glassy acrylic polymer, such as a plastic copolymer of ethylene and a carboxylic acid compound selected from acrylic acid, methacrylic acid and a mixture thereof, with elastomeric components, for example.

In another embodiment, the impact-modified acrylic polymer includes fine particles of elastomer dispersed uniformly in the plastic copolymer. The impact grade acrylic may include transparent toughened thermoplastic blends prepared by blending about 10 to about 99 weight percent of a block copolymer; about 0.1 to about 1 weight percent of particulate rubber having a particle size from about 0.1 to about 10 microns; and the balance a clear glassy polymer. Another suitable technique for making impact-modified acrylic polymer employs the use of a so-called “core/shell” product. These are generally polymer particles that have a central core of one polymer surrounded by a shell of another polymer. The core can be either the plastic or elastomer component and the shell will be the opposite, i.e., elastomer or plastic component.

In a particular embodiment, the acrylic is a linear impact modified acrylic. In a further exemplary embodiment, the acrylic is a branched impact modified acrylic. Generally, an acrylic exemplifying melt strain hardening behavior in the desired draw ratio domain is particularly suitable. In another exemplary embodiment, an acrylic exemplifying higher melt-phase tensile force in the desired draw ratio domain may be suitable.

Generally, the fluoropolymer is primarily formed of respective fluoropolymers such that, in the case of polymer blends, non-fluorinated polymers are limited to less than about 50 wt %, such as less than about 15 wt %, less than about 5 wt % or less than about 2 wt % of the total polymer content. In a certain embodiment, the polymer content of the fluoropolymer component is essentially 100% fluoropolymer. In some embodiments, the fluoropolymer component consists essentially of the respective fluoropolymers described above. As used herein, the phrase “consists essentially of” used in connection with the fluoropolymers precludes the presence of non-fluorinated polymers that affect the basic and novel characteristics of the fluoropolymer, although, commonly used processing agents and additives such as antioxidants, fillers, UV agents, dyes, pigments, anti-aging agents, and any combination thereof may be used in the fluoropolymer. In an embodiment, non-fluorinated polymers are present at greater than about 50 wt % of the total polymer content.

In an embodiment, the melt processable polymer is a poly(lactic acid). Typically, a poly(lactic acid) is substantially composed of units represented by the following chemical formula (1).

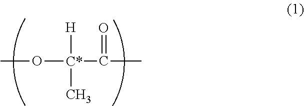

In the above chemical formula (1), C* represents an asymmetric carbon, and an S-configuration based on this asymmetric carbon provides an L-isomer unit, while an R-configuration provides a D-isomer unit. A poly(lactic acid) with an L-isomer unit is herein referred to a poly-L-lactic acid (PLLA). A poly(lactic acid) with a D-isomer unit is herein referred to a poly-D-lactic acid (PDLA). In an embodiment, the poly(lactic acid) may include L-isomers, D-isomers, or combinations thereof. Any other reasonable polymers such as poly(ethylene glycol) may be blended with the poly(lactic acid). In a certain embodiment, the polymer content of the poly(lactic acid) component is essentially 100% poly(lactic acid). In some embodiments, the poly(lactic acid) component consists essentially of the respective poly(lactic acid) described above. As used herein, the phrase “consists essentially of” used in connection with the poly(lactic acid) precludes the presence of non-poly(lactic acid) polymers that affect the basic and novel characteristics of the poly(lactic acid), although, commonly used processing agents and additives such as antioxidants, fillers, UV agents, dyes, pigments, anti-aging agents, and any combination thereof may be used in the poly(lactic acid).

The composition further includes at least one nucleating agent. The nucleating agent is blended with the melt processable polymer. Any reasonable nucleating agent is envisioned that has a surface charge opposite than the partial charge of the chemical moiety of the melt processable polymer. For instance, if the chemical moiety of the melt processable polymer has a negative partial charge, the nucleating agent has a positive surface charge. For instance, when the melt processable polymer is PVDF, the chemical moiety of the PVDF is fluorine with a negative partial charge. As such, the nucleating agent that is selected for the PVDF has a positive surface charge. Alternatively, if the chemical moiety of the melt processable polymer has a positive partial charge, the corresponding nucleating agent has a negative surface charge. It has been discovered that the opposite partial charge of the chemical moiety of the melt processable polymer to the surface charge of the nucleating agent enhances the crystalline morphology of the resulting composition. The enhanced crystalline morphology is compared to the use of a nucleating agent with a same surface charge or a neutral surface charge in relation to the partial charge of the chemical moiety of the melt processable polymer.

Additionally, the nucleating agent has a melting point above the melting point of the melt processable polymer. Melting point is the temperature at which the component (i.e. the nucleating agent and the melt processable polymer) melts from a solid state to a liquid state. It has been discovered that the melting point of the nucleating agent above the melting point of the melt processable polymer provides improved dispersion of the nucleating agent in the melt processable polymer compared to a nucleating agent that has a melting point below the melting point of a melt processable polymer. Further, the melting point of the nucleating agent above the melting point of the melt processable polymer provides improved dispersion of the nucleating agent in the melt processable polymer compared to a nucleating agent that does not melt. In a particular embodiment, the nucleating agent has a melting point above the melting point of the melt processable polymer that is about 25 degrees or less, such as about 20 degrees or less, such as about 10 degrees or less, such as about 5 degrees or less. In an embodiment, when the melt processable polymer is PVDF, the PVDF has a melting point of about 168° C. Accordingly, the nucleating agent has a melting point of between about 178° C. to about 178+10° C., or even about 186° C. to about 186+5° C. It has been discovered that both the opposite surface charge of the nucleating agent in the composition relative to the partial charge of the chemical moiety of the melt processable polymer as well as the improved melt dispersion due to the higher melting point of the nucleating agent compared to the melt processable polymer provides for an increased efficiency of crystallinity for the final composition. This is compared to a melt processable fluoropolymer with a nucleating agent having a same surface charge as the partial charge of the chemical moiety of the melt processable polymer and/or a melt processable polymer having a melting point higher than the melting point of the nucleating agent.

In an embodiment, the nucleating agent has a crystallization temperature above the crystallization temperature of the melt processable polymer. Crystallization temperature is the temperature at which the component begins crystallization, i.e. crystal microstructures begin to form that are finely distributed uniformly sized crystallites. For instance, after the melt processable polymer and nucleating agent are cooled from melting, the nucleating agent begins formation of crystals at a higher temperature than the melt processable polymer. The formation of the crystals by the nucleating agent facilitates the formation of crystals in the melt processable polymer.

Exemplary nucleating agents include a phosphonium salt, a pyridinium salt, a pyrrolidinium salt, a sulfonium salt, a sulfonate, a phosphonate, or a combination thereof. Exemplary phosphonium salts include, for example, triphenyl phosphine, tributyl phosphine, trimethyl phosphine, dimethyl phenyl phosphine, methyl diphenyl phosphine, tris(2-ethylhexyl) phosphine, tetrabutyl-phosphonium hexafluorophosphate, tetrabutyl-phosphonium-hydrogen sulfate, tetrabutylammonium-phenylphosphonate, and the like. An exemplary pyridinium salt is tritylpyridinium tetrafluoroborate. An exemplary pyrrolidinium salt is 1-butyl-1-methylpyrrolidinium bromide. An exemplary sulfonium is triphenylsulfonium tetrafluoroborate. An exemplary sulfonate is sodium octyl sulfonate. An exemplary phosphonate includes phosphonic acids, esters, and salts; phosphinic acid, esters, and salts; phosphonamides; phosphinamides; and the like. An exemplary phosphonate is tetrabutylammonium-phenylphosphonate. In a particular example, the nucleating agent is a pyrrolidinium salt. The nucleating agent is added to the composition in an amount sufficient to reduce the crystalline size of the melt processable polymer compared to a melt processable polymer without a nucleating agent. Typically, the nucleating agent is present in the composition at an amount of up to about 10.0% by weight, such as up to about 2.0% by weight, or even up to about 0.5% by weight of the total weight of the melt processable polymer.

In an exemplary embodiment, the composition further includes any additive envisioned such as fillers, dyes, pigments, modifiers, stabilizers, antioxidants, UV agents, anti-aging agents, the like, or combinations thereof. Exemplary fillers include calcium carbonate, talc, radio-opaque fillers such as barium sulfate, bismuth oxychloride, wood flour, carbon black, any combinations thereof, and the like. Exemplary dyes include any reasonable dye envisioned. Exemplary modifiers include any reasonable modifiers such as additional nucleating agents or crosslinking agents such as silanes or diisocyanates. Exemplary stabilizers include any reasonable stabilizers such as hindered amines, phenolic UV stabilizers, metal based heat stabilizers, combinations thereof and the like.

Typically, an additive may be present at an amount of not greater than about 50% by weight of the total weight of the composition, such as not greater than about 40% by weight of the total weight of the composition, or even not greater than about 30% by weight of the total weight of the composition. Alternatively, the composition may be free of fillers, dyes, pigments, modifiers, stabilizers, antioxidants, UV agents, anti-aging agents, the like, or combinations thereof.

In an embodiment, the method for obtaining the composition includes providing the melt processable polymer as described above. The components of the composition may be melt processed by any known method. In an embodiment, the melt processable polymer and nucleating agent may be melt processed by dry blending or compounding. The dry blend may be in powder, granular, or pellet form. The composition can be made by a continuous twin-screw compounding process or batch related Banbury process. The melt processable polymer is melt blended with a nucleating agent at a temperature above the melting point of the melt processable polymer. The temperature of melt blending is dependent upon the melt processable polymer chosen for the composition. Melting temperature may be at any reasonable temperature as long as the temperature is high enough to melt the melt processable polymer and the nucleating agent, however, it is sufficiently low to prevent that degradation of the components. For instance, when the melt processable polymer is PVDF, the melt temperature is between about 155° C. to about 180° C. and no higher than about 250° C. The purpose of the melt blending is to dissolve both the melt processable polymer and the nucleating agent into a liquid to form a homogeneous mixture.

Once blended, the composition is allowed to cool from the processing temperature. As cooling occurs, the nucleating agent provides an increased surface area for heterogeneous nucleation such that as the nucleating agent crystallizes to a solid, the nucleating agent starting the crystallization of the polymer. The composition of the present invention has reduced crystalline size compared to a melt processable polymer that contains a nucleating agent but with a same surface charge as the partial charge of the chemical moiety of the melt processable polymer and/or a lower melt point than the melt processable polymer as described above. In a particular embodiment, the nucleating agent of the present invention enhances the formation of crystallites wherein their size is decreased but the number of crystallites is increased in the melt processable polymer as described. Further, the nucleating agent may reduce secondary crystallization, which is the propensity of the polymer to slowly crystallize at low temperatures after the initial crystallization has occurred. Upon cooling, a solid composition is formed.

In a particular embodiment, the composition can be formed into any reasonable article by any method envisioned known in the art such as laminating, casting, extruding, extrusion coating, molding, and the like. The composition may be extruded into articles such as tubing products. In an embodiment, the composition can be injection molded. In an embodiment, any article can be made out of the compositions depending on specific application needs. Applications for the polymeric compositions are numerous.

In an embodiment, the composition may be formed into a single layer article, a multi-layer article, or can be laminated, coated, or formed on a substrate. Multi-layer articles may include layers such as reinforcing layers, adhesive layers, barrier layers, chemically resistant layers, metal layers, any combination thereof, and the like. The composition can be formed into any useful shape such as a film, a sheet, a tubing, a fiber, a molded article, and the like. The composition may adhere or bond to other substrates such as polyolefins (polypropylene (PP), polyethylene (PE), and the like), polyesters both aromatic and aliphatic, polyvinyl chloride (PVC), urethanes both cast and thermoplastic, silicone, and styrenics (polystyrene (PS), acrylonitrile butadiene styrene (ABS), high impact polystyrene (HIPS)), and the like.

In an embodiment, the composition may be used as a barrier layer. Due to the chemical barrier properties of a fluoropolymer, the composition may be used as a barrier layer where chemical resistance is desired. Further, the composition may be used where low haze is desired. The composition may be appropriate for any use where impermeability to environmental conditions such as moisture, wear resistance, and low bulk (i.e. thickness) is desired. For instance, the composition may be used to form a film for devices. Exemplary devices include framed assemblies. Framed devices include, for example, electronic devices, photovoltaic devices, insulating glass assemblies, and the like. In a particular embodiment, photoactive devices, such as electronic devices, may be formed using the composition as the outermost portion of the photovoltaic device that is in contact with the environment.

In particular, when the melt processable polymer is a poly(lactic acid), the non-toxic nature of the polymeric composition makes the material useful for any application where toxicity is undesired. For instance, the polymeric composition has potential for FDA, USP, and other regulatory approvals. In an exemplary embodiment, the composition may be used in applications such as industrial, medical, health care, biopharmaceutical, drinking water, food & beverage, laboratory, and the like.

In a particular embodiment, the composition may be used to produce tubing and hoses. For instance, the composition can be used as tubing or hosing to produce low toxicity pump tubing, reinforced hosing, chemically resistant hosing, braided hosing, and low permeability hosing and tubing. For instance, tubing may be provided that has any useful diameter size for the particular application chosen. In an embodiment, the tubing may have an outside diameter (OD) of up to about 2.0 inches, such as about 0.25 inch, 0.50 inch, and 1.0 inch. Tubing of the composition advantageously exhibits desired properties such as chemical stability and increased lifetime. For example, the tube may have a pump life greater than about 10 hours, such as greater than about 20 hours, or even greater as measured at 300 RPM using an EasyLoad II pump head.

In an embodiment, the resulting articles formed from the composition may have desirable physical and mechanical properties. For instance, the articles are flexible, kink-resistant and appear transparent or at least translucent. In particular, the articles have desirable flexibility, substantial clarity or translucency. In an embodiment, the resulting composition has a haze value such that the material has visual clarity. In an embodiment, the resulting composition has a % haze of about 10, such as a % haze of about 7, or even a % haze of about 5 as measured by ASTM-D1003.

In addition to desirable haze and hardness, the articles formed from the composition have advantageous physical properties, such as desirable elongation at break. Elongation at break is determined using an Instron instrument in accordance with ASTM D-412 testing methods. For example, the articles may exhibit an elongation at break of greater than about 20% strain, such as greater than about 50%, or even greater than about 100%.

### EXAMPLES

A melt processable polymer is KYNAR®-brand fluoropolymer, which is a PVDF commercially available from Arkema Inc. of King of Prussia, Pa., USA. To the PVDF, three types of nucleating agents are melt blended. First, positive nucleating agents (NAps), Tetrabutylphosphonium hexafluorophosphate (NAp-1), Ethyltriphenylphosphonium bromide (NAp-2), n-Heptyltriphenylphosphonium bromide (NAp-3), N-Acetonylpyridinium bromide (NAp-4), 1-Butyl-1-methylpyrrolidinium bromide (NAp-5), Tetrabutylammonium hydrogen sulfate (NAp-6) and Triphenylsulfonium tetrafluoroborate (NAp-7), are used without further purification. Second, negative nucleating agents (NAns), Sodium lauryl sulfate (NAn-1), Sodium n-tridecyl sulfate (NAn-2), 1-Naphthyl phosphate monosodium salt monohydrate (NAn-3) and third, neutral nucleating agent Flavanthone (neutral), are used. The nucleating agents are selected with melting temperature near or above that of PVDF.

The films of PVDF with different nucleating agents are obtained from the mixture of their separate acetone solutions in desired compositions. PVDF and nucleating agent solutions are separately prepared by dissolving them in acetone with stirring at about 60° C. for one day. Subsequently, PVDF and nucleating agent solutions are mixed together, containing about 2.0 wt % nucleating agent per unit weight of PVDF. The mixtures are stirred for several hours at room temperature then dried in a vacuum oven for one day or more at room temperature to remove the residual acetone.

To evaluate the dispersion of nucleating agents, a drop of solution is placed on a glass cover slip. The solution is then evaporated. The efficiency of nucleating agents depends on their ability to be dispersed within the polymer melt. To elucidate the dispersion of nucleating agents in the PVDF, optical microscopy is conducted at 220° C. In this case, only crystallites formed by nucleating agents can contribute to the negative birefringence. High dispersion is achieved for both the positive nucleating agent as well as the negative nucleating agents. For PVDF-neutral blends, some aggregates are observed.

These films are heated above melting and studied using different thermal profiles. Differential scanning calorimetry is performed using a TA Instrument Model Q100 equipped with an RCS cooling system and a nitrogen gas purge with a flow rate of 50 mL/min. The instrument is calibrated with an indium standard (Tₘ=156.6° C.). The experiments are conducted in the temperature range of about 0° C. to about 220° C. For the non-isothermal crystallization study, the samples are heated up to 220° C. at a rate of 10° C./min under nitrogen atmosphere and held at about 220° C. for about 5 minutes in order to eliminate the previous thermal history. The samples are cooled to 0° C. at a rate of 10° C./min in order to evaluate the crystallization temperature. Usually the samples obtained are then reheated to 220° C. at a heating rate of 10° C./min in order to evaluate the crystallinity obtained. DSC parameters of non-isothermal crystallization and subsequent melting for the pure PVDF and PVDF with positive nucleating agents can be seen in Table 1 wherein T_{c}: non-isothermal crystallization temperature; Tₘ: the subsequent melting point; ΔHₘ: enthalpic change; and χ_{c}: degree of crystallinity.

TABLE 1

| Samples | T_{c} (° C.) | Tₘ (° C.) | ΔHₘ (J/g) | χ_{c} (%) |
|---|---|---|---|---|
| PVDF | 139 | 168 | 48 | 46 |
| PVDF-NAp-1 | 138 | 174 | 54 | 52 |
| PVDF-NAp-2 | 146 | 175 | 52 | 50 |
| PVDF-NAp-3 | 146 | 176 | 57 | 54 |
| PVDF-NAp-4 | 137 | 172 | 51 | 49 |
| PVDF-NAp-5 | 147 | 176 | 55 | 53 |
| PVDF-NAp-6 | 143 | 177 | 54 | 52 |
| PVDF-NAp-7 | 141 | 177 | 53 | 51 |

In contrast, non-isothermal crystallization temperatures of PVDF with negative nucleating agents are shown in Table 2. It can be clearly seen that T_{c} decreases slightly (˜2 degrees), and is more difficult to crystallize, with the addition of negative nucleating agents to the PVDF that has a chemical moiety with a negative charge. Although these negative nucleating agents are well dispersed, and should enhance crystallization and increase T_{c}, they have instead suppressed crystallization and slightly decreased T. Further, the nucleating agents with a neutral surface increased T_{c} by only 2° C. The crystallization kinetics is similar to the negatively charged nucleating agents.

TABLE 2

| Samples | T_{c} (° C.) | Tₘ (° C.) | χ_{c} (%) |
|---|---|---|---|
| PVDF | 139 | 168 | 46 |
| PVDF-NAn-1 | 137 | 172 | 46 |
| PVDF-NAn-2 | 137 | 172 | 47 |
| PVDF-NAn-3 | 134 | 170 | 48 |
| PVDF-neutral | 141 | 171 | 46 |

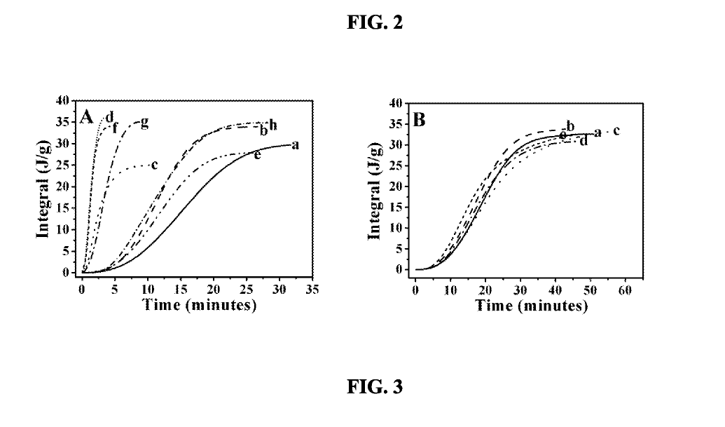

FIG. 2 are Differential Scanning calorimetry scan of (A) non-isothermal crystallization curves and (B) subsequent melting curves of PVDF and PVDF with different positive nucleating agents. As shown in FIG. 2A, the crystallization temperature (T_{c}) of the non-isothermal crystallization process shifts to higher temperatures for PVDF with positive nucleating agents except for NAp-1 and 4 as compared to neat PVDF (139° C.). It can be seen from Table 1 that the maximum shift in T_{c} is ˜8 degrees as compared to PVDF. Other positive nucleating agents exhibit smaller shifts or none (NAp-1 and 4). This indicates that the addition of these positive nucleating agents, except NAp-1 and 4, lowered the free energy barrier of nucleation, thus accelerating the crystallization of PVDF significantly, represented by a higher T_{c}. The smaller shift or none of NAp-1 and 4 is believed to be due to their high melting point.

Crystallization kinetics is carried out under isothermal crystallization conditions. Using DSC, the crystallization kinetics obtained from integrated areas of the exothermic crystallization peak is shown in FIG. 3 of PVDF and PVDF with different nucleating agents: (A) PVDF with the positive nucleating agents crystallized at ΔT=20° C., a: PVDF; b: PVDF-NAp-1; c: PVDF-NAp-2; d: PVDF-NAp-3; e: PVDF-NAp-4; f: PVDF-NAp-5; g: PVDF-NAp-6, and h: PVDF-NAp-7; (B) PVDF with negative and neutral nucleating agents crystallized at ΔT=20° C., a: PVDF; b: PVDF-NAn-1; c: PVDF-NAn-2; d: PVDF-NAn-3, and e: PVDF-neutral. The enthalpic changes for isothermal crystallization (ΔH_{c}) represent the degree of crystallinity (χ_{c}) as a function of time. It is clear, as shown in FIG. 3A, that the time needed to reach the final crystalline state is shortened for PVDF with positive nucleating agents, and χ_{c} also increases except PVDF-NAp-2 and 4 as compared to the neat PVDF. The crystallization rate increases significantly, especially for the PVDF with NAp-3, 5 and 6. The higher crystallization rate is ascribed to the positive surface charge of the nucleating agents employed. Although not to be bound by theory, it is believed that the extreme electronegativity of the fluorine atom (4) compared to that of the carbon atom (2.5) ensures a strong polarized C—F bond. However, as compared with the electronegativity of the carbon atom (2.5), the hydrogen atom (2.1) assures a weak partial charge associated with the C—H bond. Therefore, the strong partial charge of the C—F bonds and the oppositely charged surface of nucleating agents exhibit a natural affinity through the electrostatic interaction existing between nucleating agents and PVDF. This interaction induces more polymer chains to be adsorbed onto the surface of positive nucleating agents, lowering the free energy barrier for nucleation, thus increasing the crystallization speed.

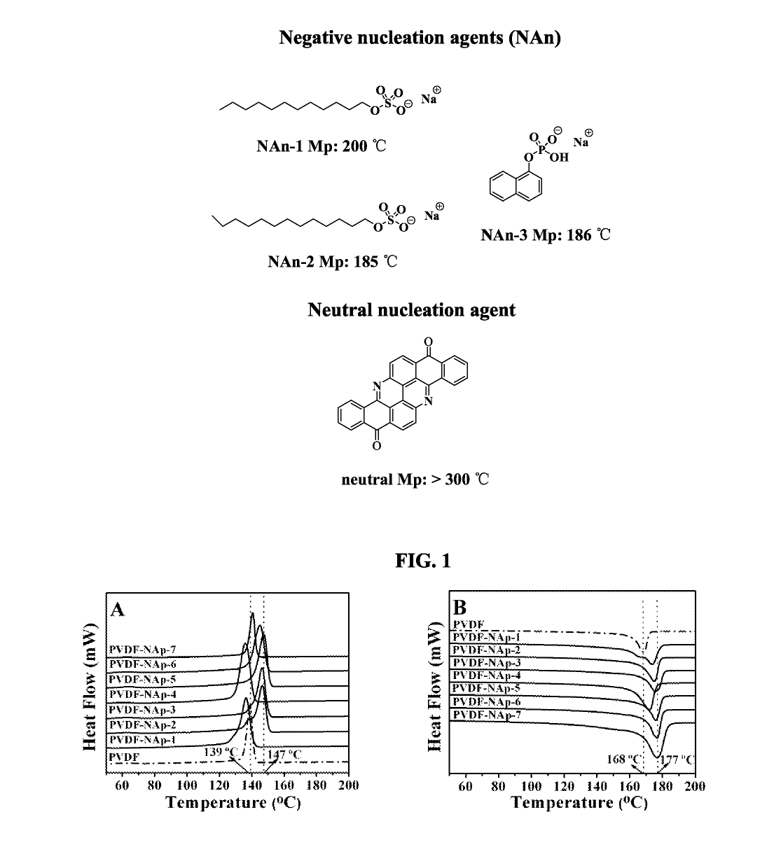

Although NAp-1 and 4 also possess positive surfaces, they affect the crystallization behavior of PVDF to a much lesser degree. This is attributed to a relatively poor dispersion of these nucleating agents because of their significantly higher melting temperatures as compared to PVDF. In contrast, the melting temperatures of NAp-3, 5 and 6 are very close to that of α phase of PVDF. In this case, the size of the positive nucleating agent nucleus is small, thus offering a substantial surface area for the PVDF chain to be adsorbed onto and facilitating the heterogeneous nucleation. Although, as seen in FIG. 1 the melting temperature of NAp-4 is also close to that of α phase of PVDF. But this nucleating agent does not disperse well in PVDF, thus accounting for its lack of effectiveness. Our results have shown that the surface charge of the nucleating agents is important. In addition, dispersion is also important in order to achieve high efficiency. In comparison, the lack of efficiency for negative nucleating agents is independent of their ability to disperse, even for samples with melting temperature very close to PVDF. This is also true for neutral nucleating agent.

Undoubtedly, the efficiency of nucleating agents depends on the degree of dispersion in the polymer. However, the surface charge of the nucleating agents is also an important factor in controlling the crystallization behavior in polymers with a chemical moiety having a strong partial charge, such as PVDF. The specific electrostatic interactions will induce more PVDF polymer chains to be adsorbed on the surface of nucleating agents, thus decreasing the free energy of nucleation. The nucleating agents with positively charged surfaces used in conjunction with the PVDF have proven to be most effective. The dispersion is also important. This is characterized by both the higher melting point of the nucleating agent compared to the melt processable polymer as well as the relative melting temperatures of the nucleating agents and PVDF. When the melting point of the nucleating agent is up to about 10 degrees higher, or even up to about 20 degrees higher than the melting point of the melt processable polymer, the more effective the nucleating agent is in crystallizing the melt processable polymer. If the melting point of the nucleating agent is higher than this point, the less effective the nucleating agent is in crystallizing the melt processable polymer.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A composition comprising:
a) a melt processable polymer including at least one chemical moiety having a partial charge; and
b) a nucleating agent having a surface charge that is opposite the partial charge of the chemical moiety of the polymer, wherein the nucleating agent accelerates the rate of crystallization of the melt processable polymer;
wherein the nucleating agent has a melting point greater than the melting point of the melt processable polymer.

2. The composition of claim 1, wherein the melting point of the nucleating agent is less than about 20 degrees greater than the melting point of the melt processable polymer.

3. The composition of claim 1, wherein the nucleating agent has a crystallization temperature above the crystallization temperature of the melt processable polymer.

4. The composition of claim 1, wherein the melt processable polymer has a carbon backbone with at least one chemical moiety with a partial charge of at least about ‥0.15 Debye.

5. The composition of claim 1, wherein the melt processable polymer is a fluoropolymer or a poly(lactic acid).

6. (canceled)

7. (canceled)

8. The composition of claim 1, wherein the nucleating agent is selected from the group consisting of a phosphonium salt, a pyridinium salt, a pyrrolidinium salt, a sulfonate, a phosphonate, and a combination thereof.

9. The composition of claim 8, wherein the nucleating agent is a pyrrolidinium salt.

10. The composition of claim 1, wherein the nucleating agent is present at an amount of up to about 10.0% by weight of the total weight of the melt processable polymer.

11. (canceled)

12. The composition of claim 1, having an increased crystallinity compared to a melt processable fluoropolymer with a nucleating agent having a same surface charge as the partial charge of the chemical moiety of the melt processable polymer, a melt processable polymer having a melting point higher than the melting point of the nucleating agent, or combination thereof.

13. The composition of claim 1, having lower haze compared to a melt processable fluoropolymer with a nucleating agent having a same surface charge as the partial charge of the chemical moiety of the melt processable polymer, a melt processable polymer having a melting point higher than the melting point of the nucleating agent, or combination thereof.

14. (canceled)

15. The composition of claim 1, wherein the chemical moiety of the melt processable polymer has a negative partial charge and the surface charge of the nucleating agent is a positive surface charge.

16. (canceled)

17. A composition comprising:
a) a melt processable fluoropolymer; and
b) a nucleating agent having a positive surface charge, wherein the nucleating agent accelerates the rate of crystallization of the melt processable fluoropolymer;
wherein the nucleating agent has a melting point above the melting point of the fluoropolymer, wherein the melting point of the nucleating agent is less than about 20 degrees greater than the melting point of the melt processable polymer.

18. The composition of claim 17, wherein the nucleating agent is selected from the group consisting of a phosphonium salt, a pyridinium salt, a pyrrolidinium salt, a sulfonate, a phosphonate, and a combination thereof.

19. (canceled)

20. (canceled)

21. (canceled)

22. (canceled)

23. (canceled)

24. (canceled)

25. (canceled)

26. A method of making a composition comprising:
providing a melt processable polymer including at least one chemical moiety having a partial charge; and
melt blending the melt processable polymer with a nucleating agent at a temperature above the melt temperature of the melt processable polymer, the nucleating agent having a surface charge that is opposite the partial charge of the chemical moiety of the polymer, wherein the nucleating agent has a melting point greater than the melting point of the melt processable polymer.

27. The method of claim 26, wherein the melting point of the nucleating agent is less than about 20 degrees greater than the melting point of the melt processable polymer.

28. The method of claim 26, wherein the nucleating agent has a crystallization temperature above the crystallization temperature of the melt processable polymer.

29. The method of claim 26, wherein the melt processable polymer has a carbon backbone with at least one chemical moiety with a partial charge of at least about −0.15 Debye.

30. The method of claim 26, wherein the melt processable polymer is a fluoropolymer or a poly(lactic acid).

31. (canceled)

32. (canceled)

33. The method of claim 26, wherein the nucleating agent is selected from the group consisting of a phosphonium salt, a pyridinium salt, a pyrrolidinium salt, a sulfonate, a phosphonate, and a combination thereof.

34. (canceled)

35. The method of claim 26, wherein the nucleating agent is present at an amount of up to about 10.0% by weight of the total weight of the melt processable polymer.

36. (canceled)

37. The method of claim 26, wherein the composition has an increased crystallinity compared to a melt processable fluoropolymer with a nucleating agent having a same surface charge as the partial charge of the chemical moiety of the melt processable polymer, a melt processable polymer having a melting point higher than the melting point of the nucleating agent, or combination thereof.

38. The method of claim 26, wherein the composition has a lower haze compared to a melt processable fluoropolymer with a nucleating agent having a same surface charge as the partial charge of the chemical moiety of the melt processable polymer, a melt processable polymer having a melting point higher than the melting point of the nucleating agent, or combination thereof.

39. (canceled)

40. The method of claim 26, wherein the chemical moiety of the melt processable polymer has a negative partial charge and the surface charge of the nucleating agent is a positive surface charge.

41. (canceled)

42. (canceled)
